(19) United States
(12) Patent Application Publication
(10) Pub. No.: US 2023/0123419 A1
(43) Pub. Date: Apr. 20, 2023

(54) SYSTEMS AND METHODS FOR SUGGESTING CONTEXT-RELEVANT COMMUNICATION FREQUENCIES FOR AN AIRCRAFT

(71) Applicant: HONEYWELL INTERNATIONAL INC., Charlotte, NC (US)

(72) Inventors: Gang He, Morris Plains, NJ (US); Zhihao Qin, Shanghai (CN); Thea Feyereisen, Minneapolis, MN (US); Rakshit R, Bangalore (IN)

(73) Assignee: HONEYWELL INTERNATIONAL INC., Charlotte, NC (US)

(21) Appl. No.: 17/647,191

(22) Filed: Jan. 6, 2022

(30) Foreign Application Priority Data
Oct. 14, 2021 (IN) 202111046876

(51) Int. Cl. G08G 5/00; B64D 43/00

(52) U.S. Cl. CPC G08G 5/003; B64D 43/00; G08G 5/006; G08G 5/0065

(57) ABSTRACT

Systems and methods for suggesting, on an avionic display in an aircraft, a communication frequency that is relevant to a context of the aircraft. The method includes determining a location and orientation of the aircraft and referencing an intended flight path to determine, based thereon, the context of the aircraft. The method uses the context to reference an on-board source of a plurality of stored navigation communication frequencies. The method identifies one or more relevant navigation communication frequencies for the context and presents the relevant navigation communication frequencies in a predefined area on an avionic display.

### CROSS REFERENCE TO RELATED APPLICATION

This application claims priority to India Provisional Patent Application No. 202111046876, filed Oct. 14, 2021, the entire content of which is incorporated by reference herein.

### TECHNICAL FIELD

The following disclosure generally relates to display systems for mobile platforms. More particularly, the following disclosure relates to systems and methods for suggesting context-relevant communication frequencies for an aircraft.

### BACKGROUND

Pilots are generally required to communicate with a control agency or authority, such as air traffic control (ATC), during all phases of a flight of an aircraft. However, each phase of the flight may require a pilot to communicate with a different control agency. Additionally, these different control agencies may require communication to be exchanged at different frequencies. Further, these communication needs are shared with Urban Air Mobility (UAM) vehicles.

In a non-limiting example, after receiving a clearance for a taxi operation, a pilot may need to communicate with an airport ground control at a first frequency while performing the taxi operation, whereas a clearance to get on a runway for take-off may require the pilot to communicate with an airport control tower at a second frequency.

In typical flight operations, a pilot may have to reference a static published chart, either in paper or in an electronic format, based on a visual read of a dynamic current position of the aircraft. The static published chart typically has assignments of frequencies required for regions of the airport environment. By comparing these two elements, the pilot mentally/manually determines a communication frequency to use. This presents a technical problem, in that, a taxi operation is already a dynamic and high work-load operation, so a requirement for a mental determination of communication frequencies, particularly at that phase of flight, may further increase the already high workload and risks introducing pilot errors.

Accordingly, improved flight display systems and methods that can assess a context for an aircraft and suggest a communication frequency are desired. Furthermore, other desirable features and characteristics of the disclosure will become apparent from the subsequent detailed description and the appended claims, taken in conjunction with the accompanying drawings, brief summary, technical field, and this background of the disclosure.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

An embodiment of a display system for suggesting a communication frequency that is relevant to a context of an aircraft is provided. The system including: a source of an intended flight path; a position determining system configured to determine a location and an orientation for the aircraft; an on-board source of communication frequencies, having stored therein a plurality of communication frequencies; and a controller circuit operationally coupled to the source of the intended flight path, the position determining system, and the source of communication frequencies, the controller circuit configured to: determine a context of the aircraft, as a function of the intended flight path and the location; present, in a predefined area on an avionic display, a list of multiple relevant navigation communication frequencies that are relevant to the context; and tune a communication circuit to a relevant navigation communication frequency of the multiple relevant navigation communication frequencies, responsive to pilot input, or activate a relevant navigation communication frequency of the multiple relevant navigation communication frequencies, responsive to pilot input.

Also provided is an embodiment of method for suggesting, on an avionic display in an aircraft, a communication frequency that is relevant to a context of the aircraft. The method including: at a controller circuit operationally coupled to a source of an intended flight path and a position determining system, determining a location and orientation of the aircraft; referencing an intended flight path; determining a context of the aircraft, as a function of the intended flight path, a location; using the context to reference an on-board source of communication frequencies, having stored therein a plurality of navigation communication frequencies; and presenting in a predefined area on an avionic display, a relevant navigation communication frequency.

Furthermore, other desirable features and characteristics of the system and method will become apparent from the subsequent detailed description and the appended claims, taken in conjunction with the accompanying drawings and the preceding background.

### BRIEF DESCRIPTION OF THE DRAWING FIGURES

At least one example of the present invention will hereinafter be described in conjunction with the following figures, wherein like numerals denote like elements, and:

FIG. 1 shows a functional block diagram of an aircraft including a system for suggesting context-relevant communication frequencies for an aircraft, in accordance with exemplary embodiments of the present disclosure;

FIG. 2 is a flowchart illustrating a method for suggesting, on an avionic display in an aircraft, a communication frequency that is relevant to a context of the aircraft, in accordance with exemplary embodiments of the present disclosure; and

FIG. 3 is an illustration of an avionic display having a dedicated area for the display of communication frequencies determined by embodiments described herein.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any weather or flight display system or method embodiment described herein as “exemplary” is not necessarily to be construed as preferred or advantageous over other embodiments. All the embodiments described herein are exemplary embodiments provided to enable persons skilled in the art to make or use the invention and not to limit the scope of the invention which is defined by the claims.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, programmable logic arrays, application specific integrated circuits, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

As mentioned, pilots are generally required to communicate with a control agency or authority, such as air traffic control (ATC) during all phases of flight. However, each flight phase may require a pilot to communicate with different control agency, and each control agency may require communication to be exchanged at different frequencies.

In a complex airport environment, an airport ground area may be divided into multiple regions each having a respective assigned ground control frequency; and each runway at that airport ground area may use a different tower frequency. In a taxi operation in the complex airport environment, the taxi route may transit the aircraft through two or more of the multiple regions, requiring that the pilot change ground control frequencies accordingly. Further, when crossing a runway during taxi operations, the pilot may have to switch from ground control frequencies to tower frequencies to obtain a crossing clearance.

In available solutions to these technical challenges, static published charts are provided to pilots in paper or in an electronic format; the charts typically state the assigned frequencies required for each of the multiple regions of the airport environment. The pilot must reference the static published chart, based on a visual read of a displayed dynamic current position of the aircraft. By comparing these two elements, the pilot mentally/manually determines a communication frequency to use. However, available solutions do not resolve all technical problems associated with these operations, because a taxi operation is already a dynamic and high work-load operation, so a requirement for a mental determination of communication frequencies, particularly at that phase of flight, may further increase the already high workload and risks introducing pilot errors.

An additional technical challenge occurs in a departure phase of flight because a departure frequency may or may not be given at the time that a departure clearance is given, because departure frequencies are often associated with defined procedures. In these departure phases, a flight crew typically must reference the static published chart for each departure procedure to make sure the correct frequencies are used. For example, in a transition from an enroute phase into an approach phase, the ATC enroute instructions can be “Contact Phoenix Tower” without a specific frequency for the Phoenix tower; this may be because ATC may not be aware of approach runways for the current approach, nor be aware of a respective approach control frequency associated with the respective approach runways. In these scenarios, the pilot must specifically search and find an approach runway and an approach control frequency associated with the approach runway.

A technical solution is disclosed herein in the form of systems and methods for suggesting a communication frequency that is relevant to a context of an aircraft. Proposed embodiments offer a technical solution to these problems with a smart frequency engine that can suggest a communication frequency. Embodiments determine a communication frequency to suggest as a function of a combination of one or more of: a current phase of operations, a taxi plan, a flight plans, an aircraft position and location, and a proximity to runways. Provided embodiments provide an objectively improved human-machine interface that can significantly reduce pilot workload and potential pilot errors.

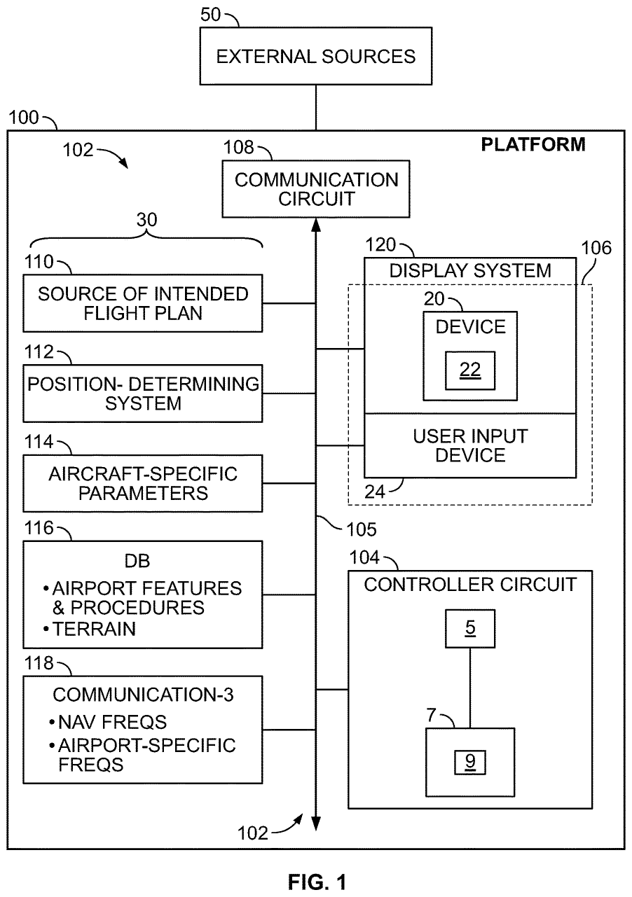

FIG. 1 is a block diagram of a system for suggesting context-relevant communication frequencies for an aircraft (shortened herein to “system” 102), in accordance with an exemplary and non-limiting embodiment of the present disclosure. The system 102 may be utilized onboard a mobile platform to provide calibration of displayed synthetic images, as described herein. In various embodiments, the mobile platform is an aircraft 100, which carries or is equipped with the system 102. Aircraft 100 may be any type of vehicle that can travel through the air (i.e., without physical contact with terrain or water). As such, aircraft 100 may be any type of airplane (regardless of size or propulsion means, ranging from large, turbine-powered commercial airplanes to small, electrically-powered drones), rotorcraft (helicopter, gyrocopter), lighter-than-air vessel (hot-air balloon, blimp), or glider, for example. Aircraft 100 may be “manned” in the conventional sense that the flight crew is present within the aircraft 100, or it may be manned remotely.

As schematically depicted in FIG. 1, system 102 includes a controller circuit 104 operationally coupled to: one or more on-board systems 30 and an HMI 106 (human-machine interface). The on-board systems 30 generally include a communications circuit 108; a source of an intended flight path 110, such as a navigation database (NavDB); a position-determining system 112, such as a navigation system; a source of aircraft-specific parameters 114; a database 116; and a communication frequencies storage 118. In various embodiments, the controller circuit 104 communicates with the other components of the system 102 via a communication bus 105. Each of the controller circuit 104, HMI 106, and on-board systems 30 may assume the form of a single device or multiple interconnected devices.

The human-machine interface, HMI 106, may generally include a display device 20 and a user input device (UI) 24. In various embodiments, the HMI 106 includes at least one instance of an integration of the user input device 24 and a display device 20 (e.g., a touch screen display). In various embodiments, the HMI 106 may include a user input device 24 such as, any combination of a keyboard, cursor control device, voice input device, gesture input apparatus, or the like. In various embodiments, the HMI 106 may include multiple display devices 20 and/or multiple user input devices 24.

The display system 120 is configured to receive and process information from various on-board aircraft systems, sensors, and databases (generally supplied via the communication bus 105), perform display processing and graphics processing, and to drive the one or more display device(s) 20 to render features in one or more avionic displays 22. The term “avionic display” is defined as synonymous with the term “aircraft-related display” and “cockpit display” and encompasses displays generated in textual, graphical, cartographical, and other formats. In various embodiments, the avionic display 22 is a primary flight display (PFD) or a navigation display. In various embodiments, the avionic display 22 can be, or include any of various types of lateral displays and vertical situation displays on which map views and symbology, text annunciations, and other graphics pertaining to flight planning are presented for a pilot to view.

As is described in more detail below, the avionic display 22 generated and controlled by the system 102 can include at least graphical user interface (GUI) objects and alphanumerical input/output displays of the type commonly presented on the screens of MCDUs, as well as Control Display Units (CDUs) generally. Specifically, embodiments of avionic displays 22 include one or more two-dimensional (2D) avionic displays, such as a horizontal (i.e., lateral) navigation display or vertical navigation display; and/or on one or more three dimensional (3D) avionic displays, such as a Primary Flight Display (PFD) or an exocentric 3D avionic display. Embodiments provide enhancements to the existing avionic displays by presenting or overlaying, on a predefined area in the avionic display, additional GUI objects and alphanumerical information, as described herein. In various embodiments, these overlays or presentations are responsive to user requests via the HMI 106. In various embodiments, a user selection of an overlay GUI object or alphanumeric text effectively selects a frequency and the system 102 may, responsive thereto, tune a communications circuit in the communication circuitry 108 to the selected frequency.

Accordingly, the display device 20 may be configured as a multi-function display (MFD) to include any number and type of image generating devices on which one or more avionic displays 22 may be produced. The display device 20 may embody a touch screen display. When the system 102 is utilized for a manned aircraft, display device 20 may be affixed to the static structure of the Aircraft cockpit as, for example, the aforementioned Head Up Display (HUD) unit, or a Head Down Display (HDD). Alternatively, display device 20 may assume the form of a movable display device (e.g., a pilot-worn display device) or a portable display device, such as an Electronic Flight Bag (EFB), a laptop, or a tablet computer carried into the Aircraft cockpit by a pilot.

In various embodiments, the HMI 106 further includes or has integrated therein an audio system capable of emitting speech and sounds, as well as of receiving speech input. In various embodiments, the HMI 106 may include any of: a graphical user interface (GUI), a speech recognition system, and a gesture recognition system. Via various display and graphics systems processes, the controller circuit 104 and display system 120 may command and control the generation, by the HMI 106, of a variety of graphical user interface (GUI) objects or elements described herein, including, for example, tabs, buttons, sliders, and the like, which are used to prompt a user to interact with the human-machine interface to provide user input, and to activate respective functions and provide user feedback, responsive to received user input at the GUI object.

An intended flight path may be a subset or part of an operational flight plan (OFP). An intended flight path may include a series of intended geospatial midpoints between a departure and an arrival, as well as performance data associated with each of the geospatial midpoints (non-limiting examples of the performance data include intended navigation data, such as: intended airspeed, intended altitude, intended acceleration, intended flight path angle, and the like). A source of the intended flight path 110 may be a storage location or a user input device. In various embodiments, a navigation database, NavDB, contains information required to construct the active trajectory or OFP. The NavDB is generally a storage location that may also maintain a database of flight plans data, and/or information regarding terrain and airports and/or other potential landing locations (or destinations) for the aircraft 100.

In some embodiments, information required to construct the active trajectory or OFP is sourced by a CNS system (Communication, Navigation, and Surveillance). In some embodiments, information required to construct the active trajectory or OFP is sourced from a “C2” (command and control center). In some embodiments, communication frequencies are at a different wavelength than Navigation frequencies.

The position-determining system 112 may include a variety of sensors and performs the function of measuring and supplying aircraft state data and measurements to controller circuit 104 and other aircraft systems (via the communication bus 105) during aircraft operation. In various embodiments, the aircraft state data includes, without limitation, one or more of system measurements providing a location (e.g., latitude and longitude), Flight Path Angle (FPA) measurements, airspeed data, groundspeed data (including groundspeed direction), vertical speed data, vertical acceleration data, altitude data, attitude data including pitch data and roll measurements, yaw data, heading information, sensed atmospheric conditions data (including wind speed and direction data), flight path data, flight track data, radar altitude data, and geometric altitude data. The position-determining system 112 may be realized as one or more of a global positioning system (GPS), inertial reference system (IRS), or a radio-based navigation system (e.g., VHF omni-directional radio range (VOR) or long-range aid to navigation (LORAN)), air data system, and it may include one or more navigational radios or other sensors suitably configured to support operation of the aircraft 100.

The source of aircraft-specific parameters 114 generally provides, for each of a variety of aircraft 100 subsystems, current status and performance data. Examples of aircraft-specific parameters include: engine thrust level, fuel level, flap configuration, braking status, temperature control system status, and the like. In an example, the aircraft system may be landing gear, and its status may be an inefficiency, such as, that it is non-retracting. As may be appreciated, the source of aircraft-specific parameters 114 may therefore include a variety of components, such as on-board detection sensors, which may be operationally coupled to the controller circuit 104, central management computer, or FMS.

Although in practice they may be combined/integrated, a database 116 and a communication frequencies storage 118 are depicted as two of two or more different onboard databases, each being a computer-readable storage media or memory. In various embodiments, onboard database 116 store two- or three-dimensional map data, including airport features data (e.g., taxi routes and runways), geographical (terrain), buildings, bridges, and other structures, street maps, and may include the aforementioned NAVDB, having stored therein navigation communication frequencies. The communication frequencies storage 118 may be an additional, customized onboard source of navigation frequencies and/or communication frequencies, having stored therein a plurality of navigation communication frequencies and airport-specific frequency coverage maps. In various embodiments, the communication frequencies storage 118 additionally stores Urban Air Mobility (UAM) vehicle profiles and communication needs.

As used herein, navigation frequencies and communication frequencies is sometimes shorted to communication frequencies. These maps may include the aforementioned static published charts stating the assigned frequencies required for each of the multiple regions of the airport environment. Specifically, the data stored in the database 116 may be regulated and periodically updated, as directed by a regulating entity, whereas the communication frequencies storage 120 may be managed and updated by the present systems and methods and is therefore able to adapt to changes more quickly. In addition, the communication database has stored therein established relationships between the intended aircraft phase/operation and associated frequencies. For example, for an aircraft phase/operation of an approach procedure (for an approach into a runway) a tower frequency for the runway and an associated approach control frequency is connected to the approach procedure. In various embodiments, the communication database may further establish a ground frequency associated with a geographic region of the selected operation (e.g., airport areas in which the approach procedure is to be performed). As such, the provided system and method can extract frequencies associated with current aircraft state/phase/operation from the on-board communication database, in a timely manner.

It should be appreciated that aircraft 100 includes many more additional features (systems, databases, etc.) than the illustrated systems 106-120. For purposes of simplicity of illustration and discussion, however, the illustrated aircraft 100 omits these additional features.

External sources 50 may include air traffic control (ATC), ground stations, a weather subscription service, other subscription services, a traffic monitoring service, a neighbor traffic, and the like. In an embodiment, a source of an external communication frequency requirement is an external source 50 (i.e., external to the aircraft 100). In an embodiment, an external communication frequency is a Tower frequency. In an embodiment, an external communication frequency is an Automatic Terminal Information Service (ATIS) frequency.

In some embodiments, the controller circuit 104 functionality may be integrated within a preexisting mobile platform management system, avionics system, cockpit display system (CDS), flight controls system (FCS), or aircraft flight management system (FMS). Although the controller circuit 104 is shown as an independent functional block, onboard the aircraft 100, in other embodiments, it may exist in an electronic flight bag (EFB) or portable electronic device (PED), such as a tablet, cellular phone, or the like. In embodiments in which the control module is within an EFB or a PED, a display system 120 and user input device 24 may also be part of the EFB or PED.

The term “controller circuit,” as appearing herein, broadly encompasses those components utilized to carry-out or otherwise support the processing functionalities of the system 102. Accordingly, in various embodiments, the controller circuit 104 can be implemented as a programmable logic array, application specific integrated circuit, system on a chip (SOC), or other similar firmware, as well as by a combination of any number of dedicated or shared processors, flight control computers, navigational equipment pieces, computer-readable storage devices (including or in addition to memory 7), power supplies, storage devices, interface cards, and other standardized components.

In various embodiments, as depicted in FIG. 1, the controller circuit 104 is realized as an enhanced computer system, having one or more processors 5 operationally coupled to computer-readable storage media or memory 7, having stored therein at least one novel firmware or software program (generally, computer-readable instructions that embody an algorithm) for carrying-out the various process tasks, calculations, and control/display functions described herein. The memory 7, may include volatile and nonvolatile storage in read-only memory (ROM), random-access memory (RAM), and keep-alive memory (KAM), for example. KAM is a persistent or non-volatile memory that may be used to store various operating variables while the processor 5 is powered down. The memory 7 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the processor 5.

During operation, the processor 5, and hence the controller circuit 104, may be programmed with and execute the at least one firmware or software program (for example, program 9, described in more detail below) that embodies an algorithm for receiving, processing, enabling, generating, updating, and rendering, described herein, to thereby perform the various process steps, tasks, calculations, and control/display functions described herein.

Controller circuit 104 may exchange data, including real-time wireless data, with one or more external sources 50 to support operation of the system 102 in embodiments. In this case, the controller circuit 104 may utilize the communication bus 105 and communications circuit 108.

In various embodiments, the communications circuit 108 includes the hardware and software to support one or more communication protocols for real-time wireless communication between the processor 5 and external sources, such as air traffic control (ATC), communication towers, ground stations, satellites, and the cloud. In various embodiments, the communications circuit 108 supports wireless data exchange over a communications network, such as bidirectional pilot-to-ATC (air traffic control) communications via a datalink; a public or private network implemented in accordance with Transmission Control Protocol/Internet Protocol architectures or other conventional protocol standards. In various embodiments, the controller circuit 104 and communications circuit 108 support controller pilot data link communications (CPDLC), such as through an aircraft communication addressing and reporting system (ACARS) router; in various embodiments, this feature may be referred to as a communications management unit (CMU) or communications management function (CMF) uplink. Encryption and mutual authentication techniques may be applied, as appropriate, to ensure data security. In various embodiments, the communications circuit 108 supports communication with technicians, and/or one or more storage interfaces for direct connection to storage apparatuses. In various embodiments, the communications circuit 108 is integrated within the controller circuit 104. With respect to the present invention, the communications circuit 108 includes the hardware and software to receive tuning commands from the controller circuit 104 and respond to tuning commands by adjusting a communication frequency used by one or more components of the communications circuit 108 to communicate with one or more external sources 50. In various embodiments, tuning commands reflect frequencies determined based on referencing the communication frequencies storage 118. In other embodiments, tuning commands reflect both (i) frequencies determined based on referencing the communication frequencies storage 118, and (ii) “external” communication frequency requirements provided by an external communication frequency source 50.

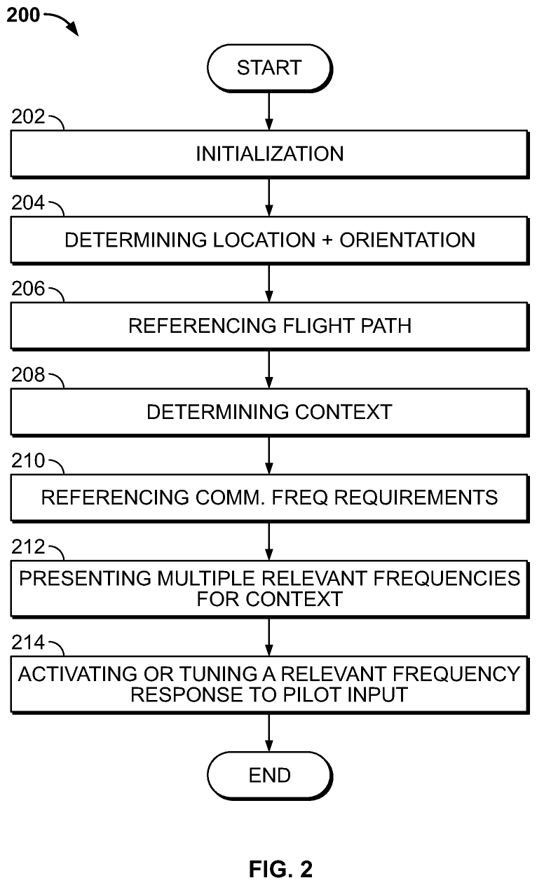

Turning now to FIG. 2, and with continued reference to FIG. 1, a flowchart of a method 200 method for suggesting, on an avionic display in an aircraft, a communication frequency that is relevant to a context of the aircraft is described, in accordance with exemplary embodiments of the present disclosure. For illustrative purposes, the following description of method 200 may refer to elements mentioned above in connection with FIGS. 1-5, for example, the tasks/operations may be performed by the controller circuit 104. In practice, portions of method 200 may be performed by different components of the described system. It should be appreciated that method 200 may include any number of additional or alternative tasks, the tasks shown in FIG. 2 need not be performed in the illustrated order, and method 200 may be incorporated into a more comprehensive procedure or method having additional functionality not described in detail herein. Moreover, one or more of the tasks shown in FIG. 2 could be omitted from an embodiment of the method 200 as long as the intended overall functionality remains intact.

At 202, the system 102 may be initialized. Initialization may include synchronizing with a remote site that manages the communication frequencies storage 120. In various embodiments, having an initialized system 102 implies that the herein described static published charts stating the assigned frequencies required for each of the multiple regions of the airport environment, are present at the beginning of flight operation, in either or both of the database 116 and communication frequencies storage 120.

At 204, the system 102 is generally rendering an avionic display. Avionic displays are described above, in connection with the display system 120. Also, at 204, the system 102 may be determining a location and an orientation of the aircraft 100, with respect to geographic markers. At 206, the system 102 may be referencing the OFP and the intended flight path to determine (at 208) a context for the aircraft 100. In various embodiments, the context may be a phase of flight, such as departure or taxi. In other embodiments, the context may be a flight procedure.

At 210, executing a novel algorithm in the program 9, the system uses the context determined at 208 to reference communication frequency requirements to identify a relevant frequency. In some embodiments, at 210, executing the novel algorithm in the program 9, the system uses the context determined at 208 to reference communication frequency requirements to identify multiple relevant frequencies. As used herein, a relevant frequency is one that is associated with the context determined in 208.

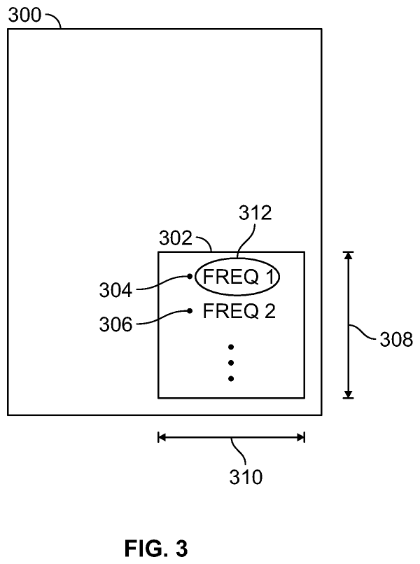

At 212, and with reference to FIG. 3, the system 102 presents the one or more relevant frequencies in a predefined area (location, extension 310 along X axis and location, extension 308 along Y axis) on an avionic display 300. While FIG. 3 depicts the dedicated area in the bottom right of the avionic display, taking up approximately one sixth of the area of the avionic display 300, readers will appreciate that this is just an example, and other embodiments may vary. In some embodiments, the one or more relevant frequencies are presented as a list in a dialog box 302. In some embodiments, the system 102 presents the one or more relevant frequencies each with an associated selectable graphical user interface (GUI) object (304, 306).

In some embodiments, after 212, the method ends or returns to 204. In other embodiments, after 212, the system 102 further receives (at 214) a selected frequency from a user input selecting the frequency and responds thereto by activating the selected navigation communication frequency, e.g., by commanding the communications circuit 108 to communicate on the selected frequency. In some embodiments, after 212, the system 102 further receives an edit (at 214) to a frequency (e.g., frequency 312), and, responsive to receiving the edit to the navigation communication frequency, tunes the associated navigation communication frequency in the communications circuit 108. In various embodiments, responsive to receiving the edit to the relevant navigation communication frequency, the system 102 further activates the edited navigation communication frequency. After 214, the method may end or may return to 204.

In various embodiments, the system 102 may determine more than one context. For example, at 208, the system 102 determines a second context of the aircraft 100, as a function of the flight path, the current location, and the current orientation, and determines (at 210) a second navigation communication frequency, as a function of the second context of the aircraft. Further, at 212, the system 102 may present the first navigation communication frequency in association with the first context and the second navigation frequency in association with the second context.

Accordingly, the present disclosure has provided several embodiments of systems and methods for suggesting a navigation communication frequency that is relevant to a context of an aircraft. Provided embodiments calculate one or more relevant navigation communication frequencies for a flight operation context of the aircraft, eliminating a dependency on a manual determination. Provided embodiments also enable selecting a relevant navigation communication frequency and promptly applying it by activating appropriate communication circuitry. Provided embodiments additionally enable manually tuning a relevant navigation communication frequency that has been presented, and promptly applying the tuned frequency to appropriate communication circuitry.

Although an exemplary embodiment of the present disclosure has been described above in the context of a fully-functioning computer system (e.g., system 102 described above in conjunction with FIG. 1), those skilled in the art will recognize that the mechanisms of the present disclosure are capable of being distributed as a program product (e.g., an Internet-disseminated program 9 or software application) and, further, that the present teachings apply to the program product regardless of the particular type of computer-readable media (e.g., hard drive, memory card, optical disc, etc.) employed to carry-out its distribution.

Terms such as “comprise,” “include,” “have,” and variations thereof are utilized herein to denote non-exclusive inclusions. Such terms may thus be utilized in describing processes, articles, apparatuses, and the like that include one or more named steps or elements but may further include additional unnamed steps or elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A display system for suggesting a communication frequency that is relevant to a context of an aircraft, comprising:
a source of an intended flight path;
a position determining system configured to determine a location and an orientation for the aircraft;
an on-board source of communication frequencies, having stored therein a plurality of navigation communication frequencies; and
a controller circuit operationally coupled to the source of the intended flight path, the position determining system, and the source of communication frequencies, the controller circuit configured to:
determine a context of the aircraft, as a function of the intended flight path and the location;
present, in a predefined area on an avionic display, a list of multiple relevant navigation communication frequencies that are relevant to the context; and
tune a communication circuit to a relevant navigation communication frequency of the multiple relevant navigation communication frequencies, responsive to pilot input, or activate a relevant navigation communication frequency of the multiple relevant navigation communication frequencies, responsive to pilot input.

2. The display system of claim 1, wherein the source of the intended flight path is a flight management system (FMS), and the flight path includes a departure runway and a taxi path.

3. The display system of claim 2, wherein the context is a phase of flight.

4. The display system of claim 3, wherein the phase of flight is departure.

5. The display system of claim 4, further comprising an external source of an external communication frequency, and wherein the controller circuit is further configured to present the relevant navigation communication frequency and the external communication frequency in the predefined area on the avionic display.

6. The display system of claim 1, wherein the external communication frequency is a Tower frequency, and wherein the controller circuit is further configured to present the navigation communication frequency and the Tower frequency.

7. The display system of claim 5, wherein the external communication frequency is an Automatic Terminal Information Service (ATIS) frequency, and wherein the controller circuit is further programmed to present the navigation communication frequency and the ATIS frequency.
The display system of claim 5, where the external n communication frequency is an user defined point of interests (FBO, for example, un published service location).

8. The display system of claim 1, wherein the context is a first context and wherein the controller circuit is further configured:
to determine a second context of the aircraft, as a function of the flight path, the current location, and the current orientation;
select a second communication frequency from among the plurality of navigation communication frequencies, as a function of the second context of the aircraft; and
present the first communication frequency in association with the first context and the second communication frequency in association with the second context.

9. A method for suggesting, on an avionic display in an aircraft, a communication frequency that is relevant to a context of the aircraft, comprising:
at a controller circuit operationally coupled to a source of an intended flight path and a position determining system,
determining a location and orientation of the aircraft;
referencing an intended flight path;
determining a context of the aircraft, as a function of the intended flight path, a location;
using the context to reference an on-board source of communication frequencies, having stored therein a plurality of navigation communication frequencies; and
presenting in a predefined area on an avionic display, a relevant navigation communication frequency.

10. The method of claim 9, further comprising,
tuning a communication circuit to the relevant navigation communication frequency, responsive to pilot input; and
activating the tuned relevant navigation communication frequency.

11. The method of claim 9, further comprising, activating the relevant navigation communication frequency of the multiple relevant frequencies, responsive to pilot input.

12. The method of claim 9, wherein the relevant frequency is one of multiple relevant navigation communication frequencies for the context, and further comprising presenting, in the predefined area on an avionic display, a list of the multiple relevant navigation communication frequencies that are relevant to the context.

13. The method of claim 9, wherein the source of the intended flight path is a flight management system (FMS), and the flight path includes a departure runway and a taxi path.

14. The method of claim 9, wherein the context is a phase of flight.

15. The method of claim 9, wherein the phase of flight is departure.

16. The method of claim 9, further comprising:
receiving, from an external source, an external communication frequency; and
presenting the relevant navigation communication frequency and the external communication frequency in the predefined area on an avionic display.

17. The method of claim 9, further comprising:
receiving, from an external source, a Tower frequency; and
presenting the relevant navigation communication frequency and the Tower frequency in the predefined area on an avionic display.

18. The method of claim 9, further comprising:
receiving, from an external source, a Tower frequency; and
presenting the relevant navigation communication frequency and the Tower frequency.

19. The method of claim 9, further comprising:
receiving, from an external source, an Automatic Terminal Information Service (ATIS) frequency; and
presenting the relevant navigation communication frequency and the ATIS frequency.

20. The method of claim 9, further comprising:
determining a second context of the aircraft, as a function of the flight path, the current location, and the current orientation;
selecting a second navigation communication frequency, as a function of the second context of the aircraft; and
presenting the first navigation communication frequency in association with the first context and the second navigation frequency in association with the second context.
